(19) United States
(12) Patent Application Publication
(10) Pub. No.: US 2026/0245472 A1
(43) Pub. Date: Aug. 20, 2026

(54) ADAPTIVE LEARNING TECHNOLOGIES TO MONITOR, UPDATE, AND ORGANIZE STUDENT EDUCATIONAL SUBJECT MATTER CORRESPONDING TO MASTERY LEVELS

(71) Applicant: 2hr Learning, Inc., Austin, TX (US)

(72) Inventor: Zain Lakhani, Brampton (CA)

(73) Assignee: 2hr Learning, Inc., Austin, TX (US)

(21) Appl. No.: 19/352,299

(22) Filed: Oct. 7, 2025

Related U.S. Application Data
(60) Provisional application No. 63/704,438, filed on Oct. 7, 2024.

(51) Int. Cl. G09B 7/00

(52) U.S. Cl. CPC G09B 7/00

(57) ABSTRACT

A mastery level determination system and method to determine the mastery level of the user based on user past performance data and assessment results, while using the online learning platform is disclosed. The mastery level determination system involves accessing the user's past performance data and assessment data. The collected data is analyzed by the mastery module, which is used to guide the content generator to generate content based on the user interaction with the online learning platform. The content generator displays a set of questions on the online learning platform. The mastery module analyzes the user interactions and updates the mastery scores and mastery level of the user. The adaptive learning system provides recommendations based on the generated output.

### CROSS-REFERENCE TO RELATED APPLICATION(S)

This application claims the benefit under 35 U.S.C. § 119 (e) and 37 C.F.R. § 1.78 of U.S. Provisional Application No. 63/704,438, which is incorporated by reference in its entirety.

### FIELD OF THE INVENTION

The present invention relates in general to the field of electronics, and more specifically to personalized learning by integrating a mastery-based approach based on a scoring system to achieve mastery in a lesson plan by answering a series of progressively challenging questions tailored to a learning curve.

### BACKGROUND OF THE INVENTION

Traditional education systems rely on time-based learning which structures the educational content based on the specific time intervals. The time-based learning system requires the students to move through the educational content based on a predetermined schedule. In time-based models, time is so central to completion that the students may graduate without mastering the required competencies which can lead to gaps in knowledge and understanding. Time-based learning helps students to maintain focus and manage time effectively, however, the schedules are fixed for each student and do not accommodate individual learning paces leading to disparity in student understanding and performance.

Historically standardized testing is utilized in time-based understanding to assess the understanding of the student and to assess their school performance. The standardized tests are administered and scored similarly. The standardized tests or assessments may be provided to the student in the form of a written test, oral test, or a practical test. Each student within the class takes a similar test and grades are provided to the students similarly. However standardized testing follows a one-size-fits-all approach and encourages teachers to test what the students have learned the entire year rather than focusing on comprehensive understanding and mastery of the subject matter.

Traditionally adaptive learning systems have been employed in educational platforms. The adaptive learning systems adjust and tailor the learning experience to meet the needs of each student. The adaptive learning system adjusts the difficulty of questions based on the responses given by the user. However, the adaptive learning systems do not ensure mastery but rather aim to keep students engaged without a structured path to learning progression.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary mastery level determination system using the mastery score of a user to provide recommendations.

FIG. 2 depicts an exemplary mastery level determination process based on the mastery score of the user.

FIG. 3 depicts a data structure for organizing data to track progress and mastery at various levels using the mastery module.

FIG. 4 depicts a network structure showing the structure of items and modules and their interaction based on prerequisite relationships.

FIG. 5 depicts an exemplary user's mastery tracking process, which is an embodiment of the mastery level determination process based on the mastery score of the user of FIG. 2.

FIG. 6 depicts an exemplary user's sequential educational process, which is an embodiment of the mastery level determination process based on the mastery score of the user of FIG. 2.

FIG. 7 depicts an exemplary network environment in which the mastery level determination system and the mastery level determination process may be practiced.

FIG. 8 depicts an exemplary computer system.

### DETAILED DESCRIPTION

A mastery level determination system to determine the mastery level of user based on mastery score of a user is disclosed. The mastery level determination system utilizes an adaptive learning system coupled with an online learning platform. The adaptive learning system includes a user information module which fetches the input data from user profile. The input data includes user's assessment data, and user's past performance data. The adaptive learning system utilizes a mastery module to analyze the mastery level of the user based on the user's past performance data, and assessment data. The mastery module analyzes the user's past performance data and provides insights to a content generator to generate learning content based on the user's initial mastery level of the user. The content generator displays a set of questions to the user on the online learning platform. The responses of the user are analyzed using a performance evaluation module to analyze the correct and incorrect responses given by the user. Based on the responses the mastery module updates the mastery score and mastery level of the user.

The mastery level determination system provides personalized learning paths tailored to each user, ensuring that all users, regardless of their starting skill level, can achieve mastery in various subjects by progressing through increasingly challenging questions. The mastery level determination system helps in boosting up the user's confidence and engagement with the material. The system also provides users with standardized tests which ensures that the user can handle questions of varying difficulty, aligning with the types of challenges they will face in actual test scenarios. The mastery level determination system encourages active learning and recommendations are provided such that immediate correction helps solidify understanding and prevent the reinforcement of incorrect concepts.

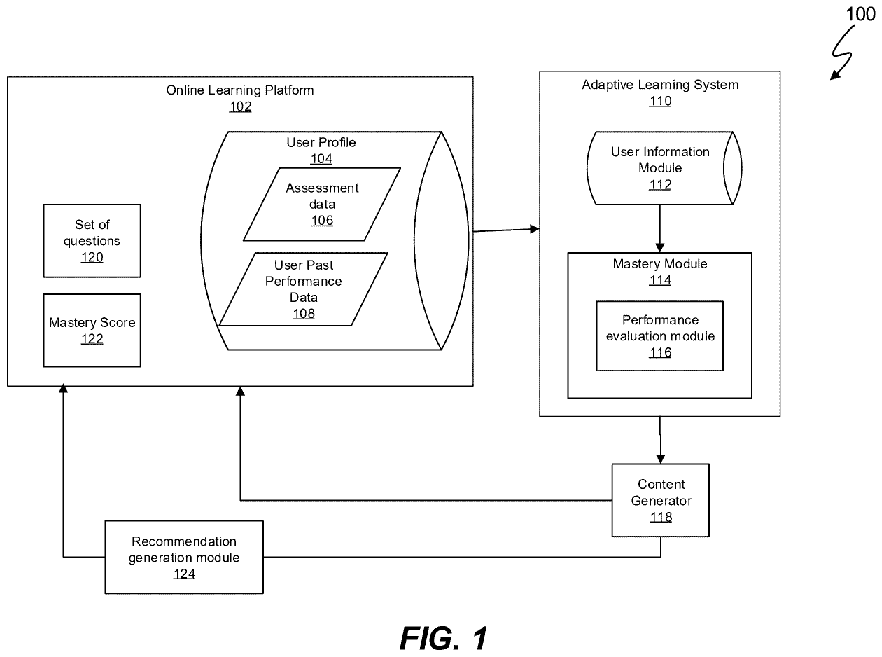

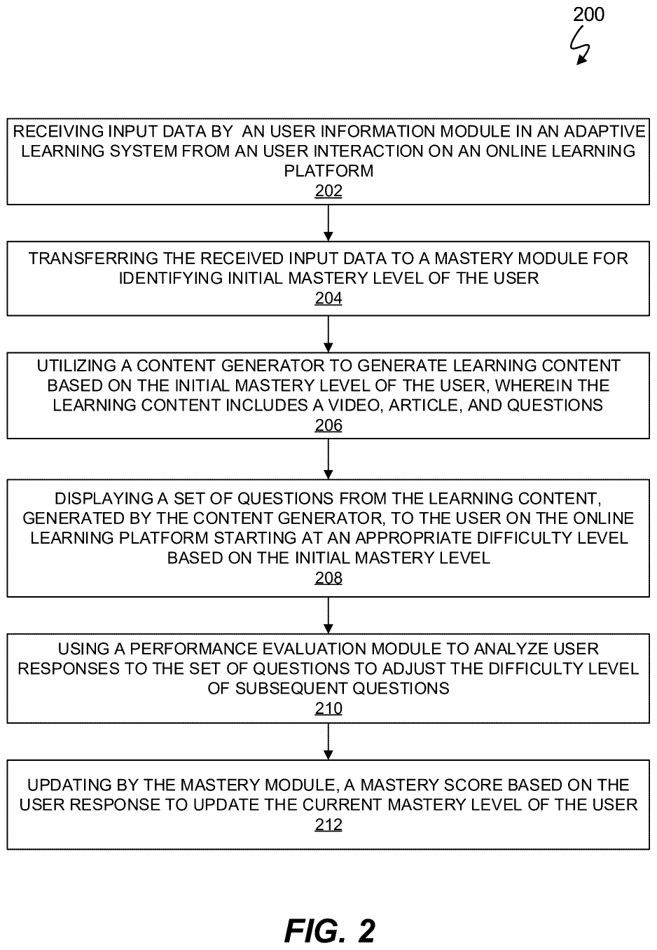

FIG. 1 depicts an exemplary mastery level determination system 100 using the mastery score 122 of a user to provide recommendations. FIG. 2 depicts an exemplary mastery level determination process 200 based on the mastery score 122 of the user, by utilizing the mastery level determination system 100.

Referring to FIGS. 1 and 2, in operation 202, a user information module 112 receives input data from a user interaction on an online learning platform 102. The input data includes assessment data 106 and user past performance data 108.

The user information module 112 is integrated into an adaptive learning system 110. The adaptive learning system 110 is operatively coupled to the online learning platform 102. The adaptive learning system 110 customizes the learning content to meet each user's needs and abilities. The learning content refers to the topics a user needs to study to attain mastery in that lesson or course. The learning content can include information, concepts, skills, and different activities relevant to that lesson that help the user achieve mastery. The adaptive learning system 110 ensures that all the users regardless of their skills at an initial stage can achieve mastery in various topics of the lesson. As the user interacts with the adaptive learning system 110, the adaptive learning system 110 continuously adapts to the user's learning needs and adjusts the difficulty of the learning content provided, ensuring that each user is engaged at their optimal challenge.

The user information module 112 fetches the input data from user profile 104 of the online learning platform 102. The user profile 104 is stored in memory (not shown in the figure) of the online learning platform 102. The user information module 112 receives input data from the user profile 104. In one of the embodiments, the user profile 104 contains information associated with each user such as age, name, and grade. The user profile 104 integrates two modules that act as input data for the user information module 112. The input data received from the user profile 104 includes assessment data 106 and user past performance data 108. Input data keeps on updating on a real-time basis as the user interacts with the online learning platform 102.

The assessment data 106 stored within the user profile 104 includes information on the user's response to pre-generated questions to evaluate the understanding of the user of a concept. In one of the embodiments, the pre-generated questions may be an MCQ, true-false, fill-in-the-blanks, and so on. The assessment data 106 is critical to monitor the progress, identify gaps in the understanding of the user, and provide feedback to motivate the users.

The user's past performance data 108 from the user profile 104 includes information on previous academic results and achievements. The user's past performance data 108 includes the assessment results which are defined as the records of the user of the particular grade. The records include the percentage of the user in that grade. The user's past performance data 108 provides a comprehensive overview of the user's overall academic journey and growth. The user's past performance data 108 includes details of the grades from the previous courses, report cards, and any comments mentioned in the report cards. For instance, the comments may include distraction, enthusiasm, and so on. The user's past performance data 108 is critical to understanding the overall academic trajectory of the user by identifying the strengths and weaknesses in various concepts related to the lesson. For instance, the user's past performance data 108, which includes the user's previous academic record is provided by the user who is switching from one school to another, or the user's past performance data 108 may include the mastery level attained by the user or educational course covered by the user in some other online learning platform or institution.

The user information module 112 receives the input data and ensures that the adaptive learning system 110 has comprehensive and well-rounded data to determine the mastery of the user. The user information module 112 collects details which include details of the user's first name, last name, grade, age, and date of birth, and collects details of another subset such as the name of assessment, grade, score, and percentile obtained in the previous grade. For instance, the user information module 112 collects information about the user such as ‘first name: John’, ‘last name: Williams’, ‘Age: 12’, ‘grade: 6th’, ‘percentage: 60 percentile, ‘grade of assessment: C’. This information can be utilized to assess the mastery level of the user.

In operation 204, the user information module 112 transfers the received input data to a mastery module 114 to identify an initial mastery level of the user.

The mastery module 114 is integrated into the adaptive learning system 110 and receives the input data from the user information module 112. The mastery module 114 determines the mastery level of the user. For instance, suppose Peter has switched from the school ABC to the school XYZ, which utilizes the mastery level determination system 100. The XYZ school has integrated the mastery level determination system 100 within its learning environment. The user's past performance data 108 shows that the user has achieved mastery of modules 5.1 to 5.20 from Grade 5. So, the user information module 112 will fetch this data and pass it on to the mastery module 114, where the modules mastered by the user in the past will be considered as the initial mastery level of the user. If the user provides the correct answers to the questions related to the user's initial mastered levels, then the initial level of the user will be upgraded, and vice-versa.

The mastery module 114 ensures a comprehensive assessment of the user's understanding of learning content at the lesson level. The lesson level refers to how complex or advanced a lesson is based on the age, grade, and skills of the user. The lesson levels are designed to match the developmental and academic abilities of the user. The lesson levels for each grade vary. For instance, the lesson level of the 5th grader will vary from the user in the 6th grade for the same topic. For instance, the lesson plan for ‘mathematics’ for the ‘topic: fractions’ of 5th grade will have different levels such as the ‘beginner level’ where the user has basic knowledge of fractions, the ‘intermediate level’ where the user can utilize the knowledge of fractions in addition or subtraction and ‘advanced level’ where the user can combine addition, subtraction, multiplication in one single problem. These lesson levels help to meet the user's varying needs and abilities and help in achieving mastery at the particular grade. The lesson levels help to identify the mastery of the user at different levels in a particular grade.

The mastery module 114 determines the initial mastery level of the user. The initial mastery level of the user is defined as the basic knowledge the user has for a particular course or lesson. The initial mastery level of the user is decided based on the user's past performance data 108 collected from the user profile 104. In one of the embodiments, the current mastery level of the user can be determined using the user's past performance data 108 or by providing an assessment test on the online learning platform 102. The user's past performance data 108 contains information about the grade of the user and, the percentage he/she received in the previous grade. For instance, if the user got 60 percentile in grade 5, the mastery module 114 analyzes that the understanding of the user is superficial rather than a deep conceptual understanding of the lesson indicating the current mastery level to be low.

The mastery module 114 fetches data from the user information module 112 and analyzes the details of the user to identify the initial mastery level of the user. The insights generated by the mastery module 114 are used by a content generator 118 to generate personalized learning content for each user.

In operation 206, the content generator 118 generates learning content based on the current mastery level of the user where the learning content includes a set of questions, a video, and articles related to the lesson or the course.

The content generator 118 receives input from the mastery module 114 and is responsible for the generation of learning content which includes a set of questions 120, videos, and articles related to the course. The content generator 118 is operatively coupled to the online learning platform 102 and the adaptive learning system 110. The content generator 118 creates relevant learning content based on the insights given by the mastery module 114. The content generator 118 utilizes an adaptive question selection algorithm to select questions based on the user's past performance data 108 ensuring the questions are neither too easy nor too hard. The content generator 118 selects questions based on the current mastery level of the user. For instance, if the user has finished grade 5 and the user's past performance data 108 shows that the user has attained mastery on all the topics of the subject, say, US History. The mastery module 114 after analyzing the fetched input data, will provide insights to the content generator 118 that the initial mastery level of the user is all topics of US History for Grade 5. The content generator 118 will utilize this insight and generate an assessment for the user based on the US History of Grade 5. The level of difficulty of the questions will keep on changing in real-time based on the answers provided by the user. For instance, if the user keeps on providing all the answers correctly, then the level of difficulty of the questions will keep on increasing. On the contrary, if the user provides 2-3 wrong answers in continuation, then the content generator 118 will automatically decrease the level of difficulty of the questions.

The set of questions 120 includes questions relevant to a particular topic. In one of the embodiments, the set of questions 120 can be in the form of MCQs, fill-in-the-blanks, true/false, and so on. The set of questions 120 includes questions of appropriate difficulty level based on the current mastery level of the user. The difficulty level of the questions increases as the user answers the questions correctly. The set of questions 120 includes progressively harder questions to achieve a mastery score 122 based on the responses given by the user.

The videos include animations, graphics, and real-life examples which make the learning content more engaging. The videos are relevant to the course or lesson the user is taking. The videos include educational content relevant to the course. The videos help to build a framework. The articles are also related to the educational topics which are a part of the user's curriculum.

The mastery score 122 is defined as a qualitative value that reflects the mastery of the user for a particular topic. The mastery score 122 is used to determine how well the user understands the concept based on the questions presented to the user. The mastery score 122 reflects the progress of the user for the particular lesson plan.

In operation 208, the content generator displays 118 a set of questions 120 to the user on the online learning platform 102 based on the initial mastery level.

The content generator 118 displays a set of questions with appropriate difficulty levels to the user based on the initial mastery level. The set of questions 120 is displayed to the user on the online learning platform 102 via., a user interface (not shown in the figure). The user interface is integrated into the online learning platform 102. The user interacts with the set of questions presented on the online learning platform 102 and based on the answers provided by the user a course graph keeps on updating on a real-time basis. As the user logs onto the online learning platform 102, each user has the course graph. The course graph includes a list of different courses or lessons along with the topics covered in that course. The course graph defines a lesson plan the user has to go through the entire year to attain mastery of the particular grade. The course graph covers all the topics related to that course.

For instance, the course graph of the user at the start includes different modules to be covered by the user for that particular course to attain mastery of that course. As the user interacts with the set of questions 120 displayed on the online learning platform 102, the course graph updates. The course graph may upgrade or degrade based on the answers to the questions provided by the user. For instance, if a user of Grade 4 is accessing the set of questions 120 on the online learning platform 102. Since the mastery module 114 after analyzing the input data will consider the initial mastery level of the user as Grade 4. So, the content generator 118 will provide a set of questions 120 related to Grade 4. The level of the questions will keep on changing based on the answers provided by the user. If the user provides incorrect answers, the question 120 difficulty level will decrease. But if the user keeps on providing incorrect answers, the mastery level determination system 100 will degrade the course graph and the mastery level of the user will also be shifted to Grade 3.

The course graph is defined by the modules which represent the units in the course. Each module contains different items. Items include a video or exercise for the module. The content generator generates 118 items based on the responses given by the user thus changing the course graph for each user as the user answers to the set of questions 120 presented on the online learning platform 102. For each user, the course graph at the start of the test is the same such as the course proceeds in a manner A to B to C to D to achieve mastery level in the particular topic.

As the user gives responses to the set of questions 120, the user profile 104 updates, and the updated responses are stored within the user profile 104. The updated responses are utilized by the mastery module 114 to evaluate the understanding of the user of that concept. The user profile 104 transfers the updated responses of the user to the user information module 112. The user information module 112 updates the information of the user in real time to provide insights to the mastery module 114 to update the mastery level of the user.

In operation 210, a performance evaluation module 116 analyzes the user responses to adjust the difficulty level of the subsequent questions and the learning content.

The performance evaluation module 116 is integrated into the mastery module 114 and receives information on responses given by the user to the set of questions 120 displayed on the online learning platform 102. The user information module 112 transfers the received responses of the user to the performance evaluation module 116. The performance evaluation module 116 analyzes the responses of the user to adjust the difficulty of subsequent questions presented to the user. The performance evaluation module 116 focuses on the evaluation of the user based on their ability to apply knowledge and skills in the real world. The performance evaluation module 116 provides a more comprehensive measure of the user's learning skills.

The performance evaluation module 116 takes into account the time spent by the user to answer a single question. For instance, if a user spends too much time answering a single question, the performance evaluation module 116 takes into account, the time spent by the user to answer the question. If the user takes too much time to answer, the performance evaluation module 116 will analyze whether the user is facing difficulty in answering the relevant question. The longer time spent by the user on the questions indicates difficulty in answering the questions and determining a little understanding of the concept. This will result in decreasing the level of difficulty of the further questions 120.

Additionally, the performance evaluation module 116 also takes into account the complexity of the questions presented to the user for that course. The performance evaluation module 116 analyzes if the correct response is given for a harder question or a simple question. If the user gets correct responses for the simple questions rather than the complex questions, the performance evaluation module 116 analyzes the shallow understanding of the concept rather than a deep understanding.

The performance evaluation module generates insights and guides the content generator 118 to adjust the difficulty level of subsequent questions for that module and change the course graph of the user to enhance the learning process. The performance evaluation module 116 analyzes the user responses in real-time to update the mastery level of the user.

The content generator 118 utilizes spaced repetition and interleaving principles to adjust the difficulty level of questions. The spaced repetition principle refers to the review of the information several times to enhance focus and long-term memory. Spaced retrieval is a learning technique that involves spreading out learning over time and regularly testing or retrieving information. It's based on research by Hermann Ebbinghaus on the forgetting curve and aims to interrupt the tendency to forget. The performance evaluation module 116 analyzes what questions the user is facing difficulty in answering and repeatedly struggling with. For instance, if the user keeps forgetting a math problem the performance evaluation module 116 guides the content generator 118 to generate questions again for the math problems the user is currently facing difficulty in. The spaced repetition principle helps the users to focus on hard topics and helps the user to remember information from time to time.

The interleaving principle helps to understand how well the users handle different types of questions when they are mixed. Interleaving is a study technique that involves mixing multiple related topics or concepts while studying, rather than focusing on one concept at a time. The performance evaluation module 116 assesses using the interleaving principle that the user is facing difficulty in answering the math problems which include addition, subtraction, and multiplication together, and guides the content generator 118 to focus on presenting questions and learning content related to these problems the user is facing difficulty in to answer.

In operation 212, the mastery module 114 updates the mastery score 122 to update the current mastery level of the user.

The user interacts with the set of questions 120 presented on the online learning platform 102 and the user responses are stored within the assessment data 106 of the user profile 104. The mastery module 114 calculates the mastery score 122 based on the responses given by the user. The performance evaluation module 116 evaluates the responses given by the user which is then utilized by mastery module 114 to update the mastery scores 122. The mastery module 114 employs a mastery calculation algorithm to evaluate the mastery level of the user on the topic by considering a series of correct answers to progressively harder questions to ensure a comprehensive assessment of the user's understanding.

The scoring mechanism ensures that the user has mastered a lesson before progressing. The mastery score 122 ranges from 0-100, where 0 indicates no knowledge of the lesson and the mastery score 122 of 100 indicates the mastery of the lesson. The scoring is achieved by answering a series of progressively challenging questions tailored to the user's learning path. The mastery score 122 is divided into different zones, where it is easy for the user to obtain the initial mastery score 122, say it is easy for the user to obtain 80. For instance, the user can obtain the mastery score 122 by covering 5 questions only. On the other hand, to obtain the higher mastery score 122, the user may have to go through plenty of questions 120, say 10 questions to achieve the final 20 mastery scores 122, thereby achieving the mastery level in that particular topic or lesson.

The mastery module 114 calculates the mastery scores 122 based on different parameters. If the user answers an initial set of questions correctly, the mastery score 122 increases from zero to a certain value. If the user answers the questions incorrectly a penalty is given on that question. As the user reaches the mastery score 122 of 100, more penalty is given on successively harder questions if the user answers the questions incorrectly, thus making it difficult to attain the mastery score 122 when moving forward toward more complex questions.

The calculation of mastery scores 122 includes a different set of rules. If the user answers correctly, the mastery score 122 should go up based on the scoring range the user is in. If the user answers incorrectly, the mastery score 122 should go down based on the scoring range the user is in. The scoring range is defined as the difference between the maximum value and the minimum value of the dataset.

Below is the calculation of the mastery score 122 based on the interaction of the user with the adaptive learning system 110:

async calculateMastery(
currentScore: number,
isCorrect: boolean,
): Promise<number> {
const ranges = [
{
start: 0,
end: 30,
increment: 16,
decrement: 8,
},
{
start: 31,
end: 50,
increment: 14,
decrement: 6,
},
{
start: 51,
end: 70,
increment: 12,
decrement: 6,
},
{
start: 71,
end: 80,
increment: 8,
decrement: 3,
},
{
start: 81,
end: 91,
increment: 6,
decrement: 6,
},
{
start: 91,
end: 100,
increment: 4,
decrement: 15,
},
];
if (currentScore >= 100) return 100;
const range = ranges.find(
(range) => currentScore >= range.start && currentScore <= range.end,
);
if (!isCorrect) {
return Math.max(currentScore − range.decrement, 0);
}
const targetScore = range.increment + currentScore;
return Math.min(targetScore, 100);
}

### Explanation

The scoring parameters are updated by the mastery module 114 to assess the mastery score 122 of the user and update the mastery level of the user. The mastery score 122 represents that each question in the level has been answered correctly by the user. The mastery score 122 should never go below 0 and above 100. As the user progresses towards the end of the questions the decrement in the mastery scores 122 increases indicating more penalty at the end of the set of questions 120 making it difficult to attain a mastery score 122 of 100. The mastery scores 122 are updated on a real-time basis based on correct answers and difficulty of questions answered.

As the user attains a mastery score 122 of 100, the current mastery level updates and indicates the mastery of the user in the lesson plan. The updated mastery scores 122 are presented to the user on the online learning platform 102 via., the user interface. The updated mastery scores 122 motivate the users, improve their self-esteem, and enhance their overall learning progress.

As the user answers each question 120, recommendations are provided to the user that help them to learn from their mistakes by utilizing a recommendation generation module 124. The recommendation generation module 124 is operatively coupled to the online learning platform 102 and the content generator 118. The generated recommendations are displayed to the user on the user interface (not shown in the figure) of the online learning platform 102. This immediate correction helps solidify understanding and prevents reinforcement of the concepts. The generated recommendations includes targeted instructions and practice problems to address user's specific needs. The content generator 118 displays relevant videos and articles relevant to the course. The recommendations further include deviation from the regular course structure and include a different path to present the learning content. The recommendations also involve focusing on topics that require more focused review.

The content generator 118 alters the learning path of the user based on the responses given by the user. The content generator 118 along with the recommendations displays a video related to the questions the user is consistently facing problems with and along with it generates an exercise related to that video to enhance the learning process.

For instance, Alice logs onto the adaptive learning system 110 using the online learning platform 102 to learn algebra. The adaptive learning system 110 assesses her initial mastery level based on past performance data 108 and assessment data 106. The mastery module 114 utilizes the data to assess the current mastery level of Alice and guides the content generator 118 to present Alice with a set of questions. As Alice answers correctly, the content generator 118 presents her with slightly more challenging problems. Each set of ten questions 120 increases in difficulty, and the mastery module 114 updates Alice's mastery score 122 in the real time. If Alice struggles with a particular concept, the content generator 118 adjusts the learning content and provides targeted instruction and practice problems to address her specific needs.

In an embodiment, the mastery level determination system 100 is an educational framework that effectively integrates several advanced teaching strategies into one cohesive form. The mastery level determination system 100 is designed to offer a personalized learning experience in correspondence with the user's requirements to meet the unique needs and learning styles of each user. This means that instruction is customized to ensure that every user can engage with the material in a way that best suits their individual preferences and strengths.

The mastery level determination system 100 highlights mastery, which involves a deep and thorough understanding of each concept before users progress to the next topic. This ensures that users build a strong foundation, minimizing gaps in knowledge. Active learning is another key component, where users are not passive recipients of information but are instead actively engaged through interactive and participatory methods. This approach helps users internalize concepts more effectively by making learning a more dynamic and engaging process.

Direct instruction is also a critical aspect, providing users with clear and structured guidance when they encounter new concepts. This helps to establish a solid understanding before users are expected to apply what they've learned. Additionally, the mastery level determination system 100 encourages learning from mistakes, thereby providing an environment where users can grow through the part where they made errors and can further correct them. This helps build flexibility and a deeper understanding of the educational content.

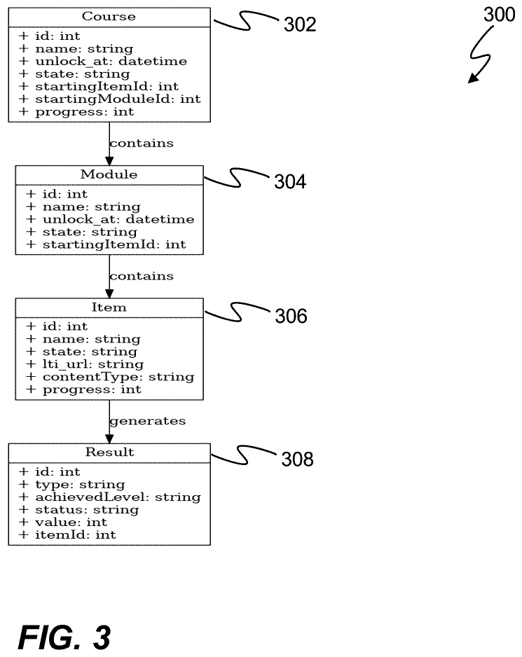

FIG. 3 depicts a data structure 300 for organizing data to track progress and mastery at various levels using the mastery module 114.

The data structure 300 comprises a plurality of nodes such as course 302, module 304, item 306, and result 308. The relationship between these nodes shows the interconnectivity between them i.e., how courses 302 contain modules 304, modules 304 contain items 306, and items 306 generate results 308.

The course 302 is defined as part of the study that contributes to the completion of academic progress. The course 302 consists of a name and a unique course ID defined for each course. The name of course 302 is defined by a string that includes different characters for the course and the unique course ID is defined by integers. For instance, courses 302 such as ‘Biology’, ‘Mathematics’, and ‘Social Science’ will have unique IDs expressed in the form of integers. The course 302 also includes information on the state of the course. The state of the course defines the course 302 initiated by the user.

The course 302 includes information on the starting item ID and starting module ID and their progress which is expressed in the form of integers. Each student has his/her data structure which is utilized by the mastery module 114 to track the progress of the user while he/she is answering the set of questions 120.

The course 302 contains different modules 304. The modules 304 are defined as topics within each course 302 containing information regarding the relevant course. Each module 304 has a unique module ID expressed in the form of an integer. The module 304 contains information on the unlocking which represents the date and time the user interacts with the module 304 and the state of the module. For instance, the user-initiated learning from the module 304 today itself and the state defines the progress of module 304 indicating the interaction of the user. The interaction of the user with the module 304 is utilized to track the progress of the module 304.

The module 304 contains item 306. Item 306 is defined as videos, exercises, or articles related to the module 304. Each item 306 has its name, unique ID, state, content type, and progress. The user interacts with the item 306, where the mastery module 114 tracks the mastery progress of the item 306. The progress is defined as the interaction of the user with item 306 and their responses to item 306. The progress of each item 306 is depicted using the mastery score 122. As the user progresses the mastery module 114 updates the mastery score 122 of the user based on the responses given by the user to the items 306 and thus track the progress.

As the user interacts with the item 306, the content generator 118 generates results 308. The results 308 include the type of learning content to be displayed to the user based on the user interaction. The results 308 update the course graph of each user aligned with his/her learning abilities.

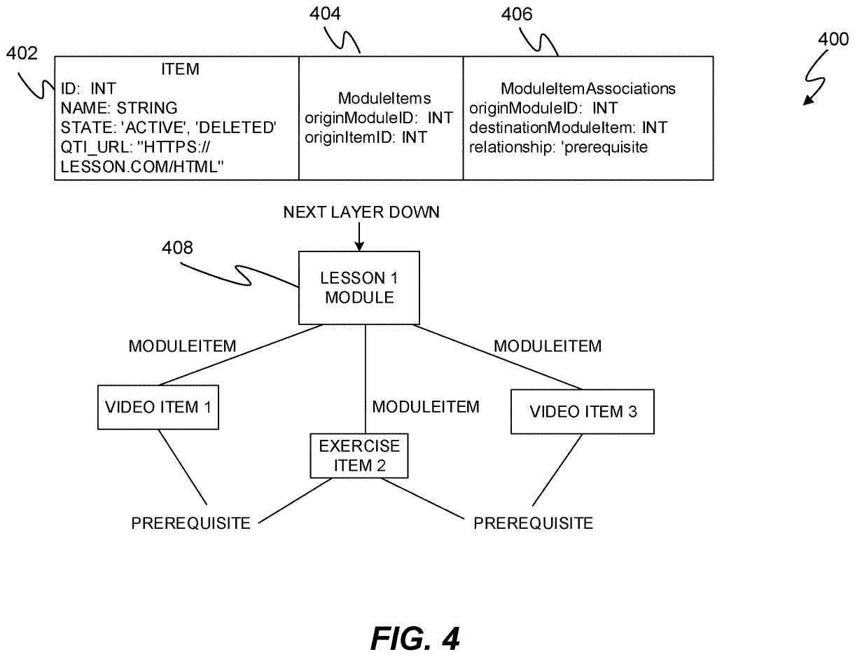

FIG. 4 depicts learning management system elements 400 and their interaction based on prerequisite relationships. The learning management system elements 400 represent a network diagram showing the structure of educational content modules and items. The learning management system elements 400 depict various elements such as ‘Item’, ‘ModuleItems’, and ‘ModuleItemAssociations’ and their relationships within a learning management system. The learning management system elements 400 outlines how items such as videos and exercises are organized within modules and how these modules interact based on prerequisite relationships to form a cohesive educational framework. Each Item 402 represents a specific piece of content, including a video, an exercise, a reading passage, or any other type of educational resource. The Item 402 includes the ID, name, and state which defines if the item is active or deleted. These items 402 are grouped together into ModuleItems 404, which are essentially collections of related content structured to form a comprehensive learning experience on a particular topic or skill. ModuleItem 404 includes the module ID. The modules are defined by videos followed by the exercise within a lesson. For instance, lesson 1 module 408 consists of three module items, video item 1, video item 3, and exercise item 2. Video item 1 is a prerequisite to exercise item 2, which is a prerequisite to video item 3. This hierarchical organization ensures that users progress through the educational content in a logical and structured manner, building on their knowledge as they move from one module to the next. In at least one embodiment, sequence numbers are not used, but rather the items are modeled using relationships with associations to create a graph or linear sequence.

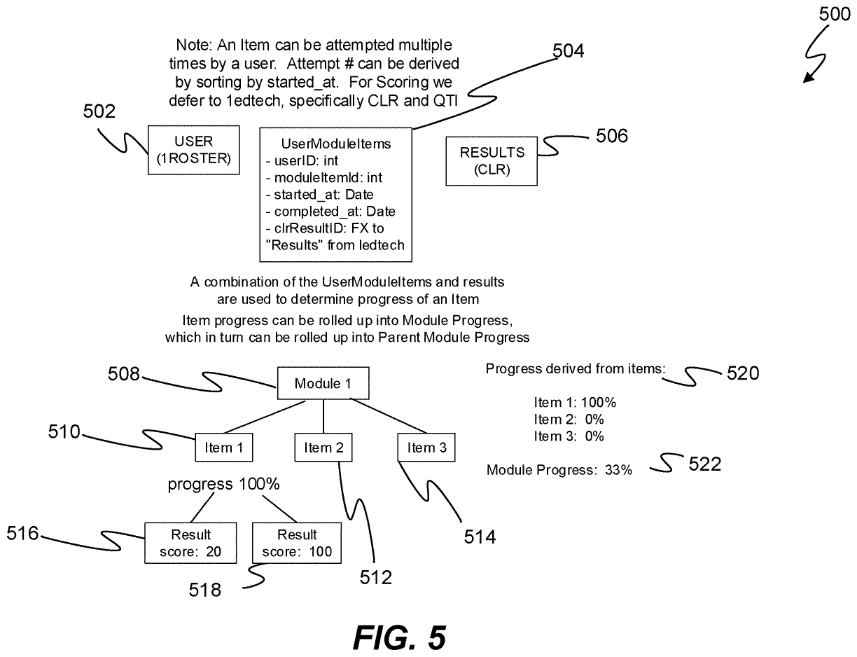

FIG. 5 depicts an exemplary user's mastery tracking process 500, which is an embodiment of the mastery level determination process 200 based on the mastery score 122 of the user of FIG. 2. The mastery tracking process 500 is depicted as a flow chart that illustrates the process of tracking educational progress through various items within a module. It includes components like User, UserModuleItems, and Results, indicating how each item's progress can be aggregated to measure overall module progress.

The user's mastery tracking process 500 tracks the mastery status of the user, when the user attempts the set of questions 120 on the online learning platform 102. The user's mastery tracking process 500 includes several key components, such as User 502, UserModuleItems 504, and Results 506, each playing a critical role in the user's mastery tracking process 500. The User 502 component represents the individual user interacting with the educational content on the online learning platform 102. As the user 502 engages with different items within a module such as videos, quizzes, or readings their progress on each specific item is tracked and recorded under UserModuleItems 504.

The user 502 logs onto an online learning platform 102 and creates a user profile 104. The user 502 includes 1roster. 1 roster is defined as a standard that allows the schools to share the information of the user such as name, age, grades, and courses. 1roster allows the transfer of user data such that the user's mastery tracking process 500 mastery progress system 500 can utilize the data to track the overall progress of user 502.

The UserModuleItems 504 component captures and stores detailed data about the user's engagement and performance on each item within the module. The User module item 504 includes details of the user ID and module item ID. Each user has a unique user ID. The user module item 504 includes details on when the user starts the module and when the user completes the module along with the results 506. The results 506 includes the scores of the user while attempting the questions within the items. The user's mastery tracking process 500 then shows how this item-specific user's mastery tracking data is analyzed to determine the mastery level of the user. The Results 506 component is where this analyzed data is compiled, offering a report of the user's mastery level across all items. This allows both users and educators to see how much of the module or lessons has been completed, identify areas where the user might need additional support, and determine when the user is ready to move on to the next module. Based on the generated insights, and user performance in the tests, the recommendations are provided to the user using the recommendation generation module 124.

A combination of user module item 504 and results are used to determine the progress of an item. The module progress can be defined by the progress of items within the module.

For instance, module 1 508 is made of three different items Item 1 510, Item 2 512, and Item 3 514. The user 502 starts by attempting the exercises presented within item 1 510. The user's mastery tracking process 500 further tracks the responses given by user 502 to update the results which at first includes the mastery score 122 of 20 516. An item 1 can be attempted multiple times by the user to update the mastery score 122 of the user to 100 (518). The Item 2 512 and the item 3 remains unattempted. The data updates in real-time are to be stored in user module item 504.

The mastery progress system 500 derives the mastery level from the items 520 attempted by the user along with the mastery score 122. As module, 1 508 consists of 3 items, the overall mastery status is defined the all three items. To achieve a module progress 522 of 100 percent the user has to attempt all three items along with a mastery score 122 of 100. Here in this case the module progress is 33% as the user attempts only Item 1 510.

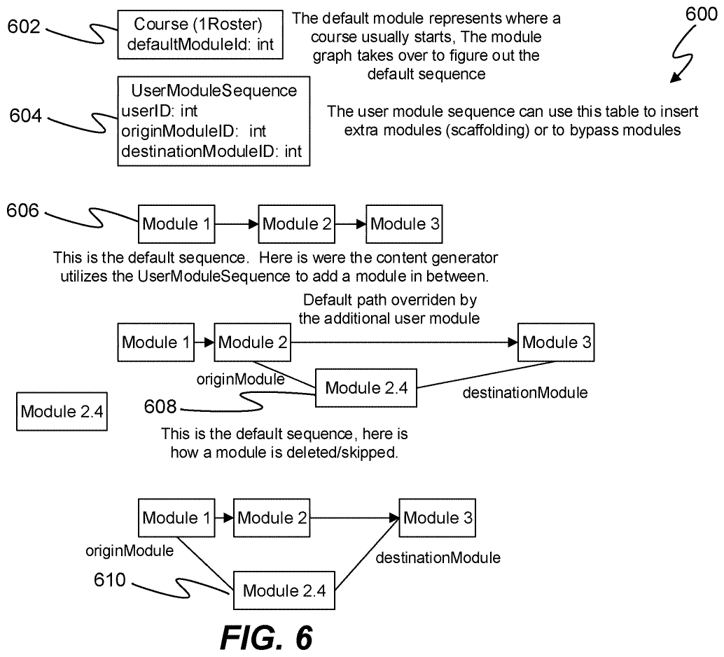

FIG. 6 depicts an exemplary user's sequential educational process 600, which is an embodiment of the mastery level determination process 200 based on the mastery score 122 of the user of FIG. 2.

The course 602 includes a default module ID. The default module represents when the user initially starts the course. The user interacts with course 602 and based on the response given by the user the content generator 118 provides customized learning content to the user.

The user module sequence 604 is utilized to insert extra modules referred to as scaffolding or bypass modules based on the responses given by the user to the set of questions. The default module sequence 606 can be module 1 to module 2 to module 3. For instance, if a user is facing problems with questions related to the use of addition and multiplication and is unable to answer the questions every time. The performance evaluation module 116 analyzes that the user is struggling with this concept and guides the content generator 118 to generate content accordingly. The content generator 118 utilizes the user module sequence 604 to add a module 2.4 606 between the default module sequence to enhance the learning process and attain mastery.

If a user has an understanding of the concept, the user module sequence 604 can be utilized to remove or skip module 610 and thus enhance the learning process.

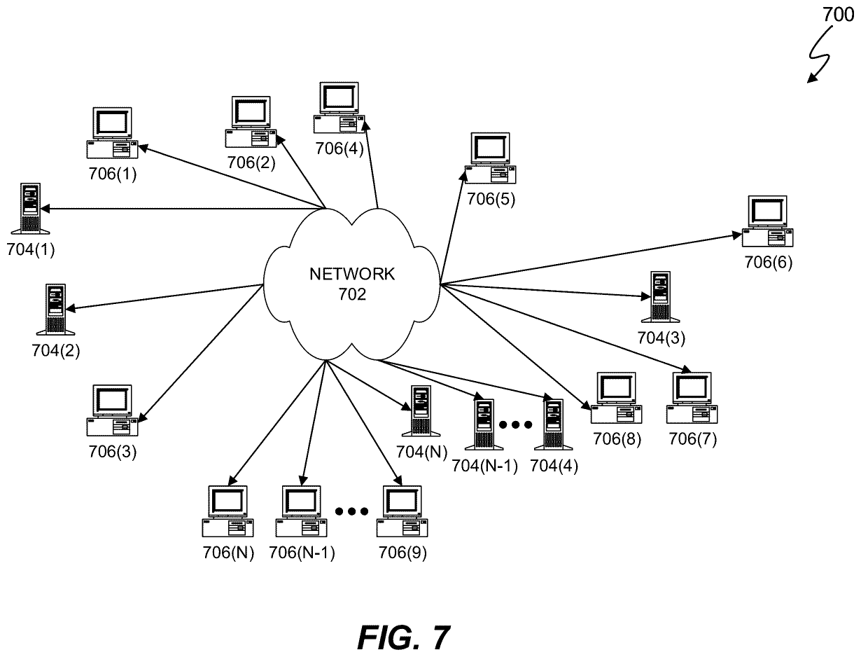

FIG. 7 is a block diagram illustrating a network environment in which a mastery level determination system 100 and mastery level determination process 200 may be practiced. Network 702 (e.g. a private wide area network (WAN) or the Internet) includes a number of networked server computer systems 704(1)-(N) that are accessible by client computer systems 706(1)-(N), where N is the number of server computer systems connected to the network. Communication between client computer systems 706(1)-(N) and server computer systems 704(1)-(N) typically occurs over a network, such as a public switched telephone network over asynchronous digital subscriber line (ADSL) telephone lines or high-bandwidth trunks, for example communications channels providing T1 or OC3 service. Client computer systems 706(1)-(N) typically access server computer systems 704(1)-(N) through a service provider, such as an internet service provider (“ISP”) by executing application specific software, commonly referred to as a browser, on one of client computer systems 706(1)-(N).

Client computer systems 706(1)-(N) and/or server computer systems 704(1)-(N) are specialized computer programmed to improve conventional computer systems to implement and utilize the mastery level determination system 100 and mastery level determination process 200. The type of computer system that can be specially programmed to implement and utilize the mastery level determination system 100 and mastery level determination process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the mastery level determination system 100 and mastery level determination process 200 can be implemented using code stored in a tangible, non-transient computer readable medium and executed by one or more processors. In at least one embodiment, the mastery level determination system 100 and mastery level determination process 200 can be implemented completely in hardware using, for example, logic circuits and other circuits including field programmable gate arrays.

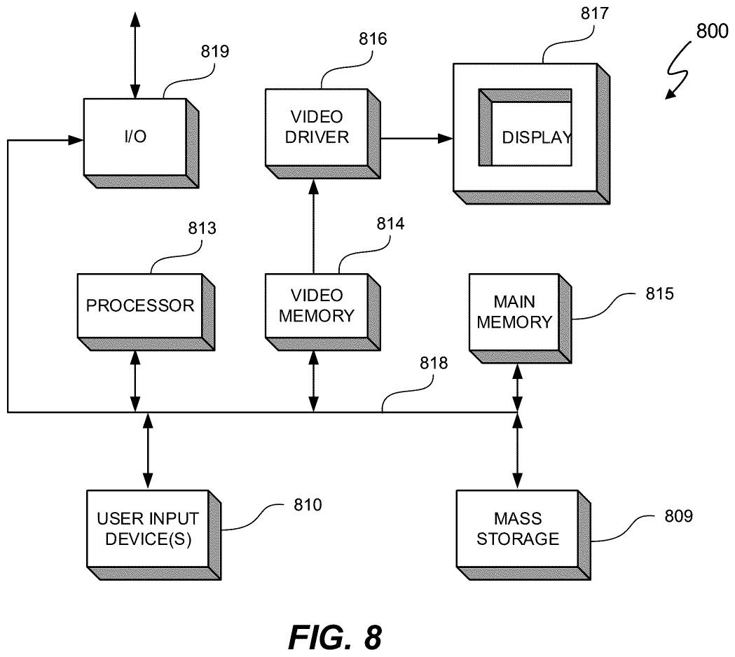

Embodiments of the mastery level determination system 100 and mastery level determination process 200 can be implemented on a computer system such as a special-purpose, special-programmed computer 800 illustrated in FIG. 8. Input user device(s) 810, such as a keyboard and/or mouse, are coupled to a bi-directional system bus 818. The input user device(s) 810 are for introducing user input to the computer system and communicating that user input to processor 813. The computer system of FIG. 8 generally also includes a non-transitory video memory 814, non-transitory main memory 815, and non-transitory mass storage 809, all coupled to bi-directional system bus 818 along with input user device(s) 810 and processor 813. The mass storage 809 may include both fixed and removable media, such as a hard drive, one or more CDs or DVDs, solid state memory including flash memory, and other available mass storage technology. Bus 818 may contain, for example, 32 of 64 address lines for addressing video memory 814 or main memory 815. The system bus 818 also includes, for example, an n-bit data bus for transferring DATA between and among the components, such as CPU Y09, main memory 815, video memory 814 and mass storage 809, where “n” is, for example, 32 or 64. Alternatively, multiplex data/address lines may be used instead of separate data and address lines.

I/O device(s) 819 may provide connections to peripheral devices, such as a printer, and may also provide a direct connection to a remote server computer systems via a telephone link or to the Internet via an ISP. I/O device(s) 819 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 809, into main memory 815 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 813, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 815 is comprised of dynamic random access memory (DRAM). Video memory 814 is a dual-ported video random access memory. One port of the video memory 814 is coupled to video amplifier 816. The video amplifier 816 is used to drive the display 817. Video amplifier Y16 is well known in the art and may be implemented by any suitable means. This circuitry converts pixel DATA stored in video memory 814 to a raster signal suitable for use by display 817. Display 817 is a type of monitor suitable for displaying graphic images.

The computer system described above is for purposes of example only. The mastery level determination system 100 and mastery level determination process 200 may be implemented in any type of computer system or programming or processing environment. It is contemplated that the mastery level determination system 100 and mastery level determination process 200 might be run on a stand-alone computer system, such as the one described above. The mastery level determination system 100 and mastery level determination process 200 might also be run from a server computer systems system that can be accessed by a plurality of client computer systems interconnected over an intranet network. Finally, the mastery level determination system 100 and mastery level determination process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for determining a mastery score of a user in real-time to identify a mastery level of the user to provide recommendations comprising:
executing codes using one or more processors of a computer system to cause the computer system to perform operations comprising:
receiving input data by an adaptive learning system from a user interaction on an online learning platform, wherein the input data include user responses to one or more pre-generated questions and user past performance data;
transferring the received input data to a mastery module for identifying an initial mastery level of the user;
utilizing a content generator to generate learning content based on the initial mastery level of the user;
displaying a set of questions from the learning content, generated by the content generator, to the user on the online learning platform starting at a difficulty level corresponding to the initial mastery level;
using a performance evaluation module to analyze user responses to the set of questions to adjust the difficulty level of subsequent questions;
updating by the mastery module, a mastery score based on the user response to update the initial mastery level to a current mastery level.

2. The method of claim 1 wherein the set of questions includes progressively harder questions provided to the user to achieve a score of 100 to update the current mastery level based on the used response.

3. The method of claim 1 further comprises:
utilizing an adaptive question selection algorithm to select questions based on the past performance of the user and a mastery calculation algorithm to determine the mastery level of the user based on correct answers.

4. The method of claim 1 wherein the mastery calculation algorithm evaluates the mastery level of the user on the topic by considering a series of correct answers to progressively harder questions to ensure a comprehensive assessment of the user's understanding.

5. The method of claim 1 wherein the content generator further comprises selecting the set of questions for an assessment based on the past performance of the user to ensure an optimal level of difficulty.

6. The method of claim 1 wherein the performance evaluation module adjusts the difficulty level of subsequent questions based on the real-time responses of the user during the assessment.

7. The method of claim 1 wherein the content generator utilizes spaced repetition and interleaving principles to generate questions with adjusted difficulty levels, real-time feedback, and updated mastery scores.

8. The method of claim 1 further comprises:
utilizing a recommendation generation module to provide recommendations to the user based on the current mastery level of the user.

9. A system for determining a mastery score of a user in real-time to identify a mastery level of the user to provide recommendations comprising:
one or more processors of a computer system;
a memory, operatively coupled to the one or more processors, storing code that when executed by the one or more processors cause the computer system to perform operations comprising:
receiving input data by an adaptive learning system from a user interaction on an online learning platform, wherein the input data include user responses to one or more pre-generated questions and user past performance data;
transferring the received input data to a mastery module for identifying an initial mastery level of the user;
utilizing a content generator to generate learning content based on the initial mastery level of the user;
displaying a set of questions from the learning content, generated by the content generator, to the user on the online learning platform starting at a difficulty level corresponding to the initial mastery level;
using a performance evaluation module to analyze user responses to the set of questions to adjust the difficulty level of subsequent questions;
updating by the mastery module, a mastery score based on the user response to update the initial mastery level to a current mastery level.

10. The system of claim 9 wherein the set of questions includes progressively harder questions provided to the user to achieve a score of 100 to update the current mastery level based on the used response.

11. The system of claim 9 further comprises:
utilizing an adaptive question selection algorithm to select questions based on the past performance of the user and a mastery calculation algorithm to determine the mastery level of the user based on correct answers.

12. The system of claim 9 wherein the mastery calculation algorithm evaluates the mastery level of the user on the topic by considering a series of correct answers to progressively harder questions to ensure a comprehensive assessment of the user's understanding.

13. The system of claim 9 wherein the content generator further comprises selecting the set of questions for an assessment based on the past performance of the user to ensure an optimal level of difficulty.

14. The system of claim 9 wherein the performance evaluation module adjusts the difficulty level of subsequent questions based on the real-time responses of the user during the assessment.

15. The system of claim 9 wherein the content generator utilizes spaced repetition and interleaving principles to generate questions with adjusted difficulty levels, real-time feedback, and updated mastery scores.

16. The system of claim 9 further comprises:
a recommendation generation module to provide recommendations to the user based on the current mastery level of the user.
